(19) United States
(12) Patent Application Publication
(10) Pub. No.: US 2015/0350220 A1
(43) Pub. Date: Dec. 3, 2015

(54) CONTROL SETTINGS

(71) Applicant: Apple Inc., Cupertino, CA (US)

(72) Inventors: Christopher D. Espinosa, Menlo Park, CA (US); Christopher John Sanders, San Jose, CA (US); Maria D. Ioveva, Menlo Park, CA (US)

(21) Appl. No.: 14/724,695

(22) Filed: May 28, 2015

Related U.S. Application Data
(60) Provisional application No. 62/005,180, filed on May 30, 2014.
(60) Provisional application No. 62/005,187, filed on May 30, 2014.

(51) Int. Cl. H04L 29/06; G06F 21/62; H04L 29/08

(52) U.S. Cl. CPC H04L 63/102; H04L 67/306; G06F 21/62

(57) ABSTRACT

One or more user accounts can be linked together to form a group of linked user accounts. A designated primary user account in the group of linked user accounts can be enabled to modify control settings for the subordinate user accounts in the group of linked user account. The control settings can dictate restrictions on the subordinate user accounts. For example, the control settings can define restrictions on the type of content that can be accessed, purchases that can be made, storage space allocated to the subordinate user account, etc. In some embodiments, the primary user account can be enabled to establish a set of control settings for a client device associated with the group of linked user accounts. The set of control settings can dictate restriction on content accessed by the client device and usage of the client device such as restrictions on phone calls, messages, data usage, etc.

### CROSS-REFERENCE TO RELATED APPLICATIONS

This application claims the benefit of U.S. Provisional Patent Application No. 62/005,180 entitled “CONTROL SETTINGS” filed on May 30, 2014, and U.S. Provisional Patent Application No. 62/005,187 entitled “PERMISSION REQUEST” filed on May 30, 2014, both of which are hereby expressly incorporated herein by reference in their entirety.

### TECHNICAL FIELD

The present technology pertains to control settings, and more specifically pertains to control settings defining restrictions on a subordinate user account in a group of linked user accounts.

### BACKGROUND

Computing devices have become a common part of daily life. For example, many families have a separate computing device for each family member. This can include desktop computers, laptops, smart phones, tablet PCs, etc. Along with the increased number of computing devices, computing devices also allow users to perform a wider range of functionality. For example, computing devices can connect to the internet from multiple locations to access various types of content, such as video, music, images, etc.

Further, online stores allow users to purchase a variety of items from the comfort of their computing device. For example, online media stores allow users to purchase a variety of electronic content items such as music, movies, books, etc., which a user can access and perform from their computing device. Mobile computing devices, such as smart phones, allow users to send messages and make phone calls.

With this increase in the number of computing devices and functionality, managing and monitoring the use of computing devices has become much more difficult. For example, a parent cannot be with their child at all times to monitor the child's use of their computing devices and the content they are accessing. Accordingly, an improvement is needed.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, devices, and non-transitory computer-readable storage media for managing control settings that define restrictions on a subordinate user account in a group of linked user accounts. One or more user accounts can be linked together to form a group of linked user accounts. A designated primary user account in the group of linked user accounts can be enabled to modify control settings for the subordinate user accounts in the group of linked user accounts. The control settings can dictate restrictions on the subordinate user accounts. For example, the control settings can define restrictions on the type of content that can be accessed, purchases that can be made, storage space allocated to the subordinate user account, etc.

In some embodiments, the primary user account can be enabled to establish a set of control settings for a client device associated with the group of linked user accounts. The set of control settings can dictate restriction on the client device. For example, the set of control settings can dictate restrictions on the type of content that can be accessed by the client device. Alternatively, the set of control settings can dictate restrictions on usage of the client device, such as restrictions on phone calls, messages, data usage, etc.

In some embodiments, a primary user account can select a set of default control settings for the subordinate user accounts. For example, a default set of control settings can be generated based on the age of a user of a subordinate user account. Further, the default set of control settings can be based on location, cultural norms, local trade associations, etc.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network in accordance with the invention;

FIGS. 2A, 2B, and 2C illustrate an exemplary embodiment of linking multiple user accounts together;

FIG. 3 illustrates an exemplary method embodiment of managing control settings for a group of linked user accounts;

FIG. 4 illustrates an exemplary method of using control settings to restrict a user account; and

FIGS. 5A and 5B illustrate exemplary possible system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for managing control settings that define restrictions on a subordinate user account in a group of linked user accounts. One or more user accounts can be linked together to form a group of linked user accounts. A designated primary user account in the group of linked user accounts can be enabled to modify control settings for the subordinate user accounts in the group of linked user account. The control settings can dictate restrictions on the subordinate user accounts. For example, the control settings can define restrictions on the type of content that can be accessed, purchases that can be made, storage space allocated to the subordinate user account, etc.

In some embodiments, the primary user account can be enabled to establish a set of control settings for one or more client device associated with the group of linked user accounts. The set of control settings can dictate restriction on the client device. For example, the set of control settings can dictate restrictions on the type of content that can be accessed by the client device. Alternatively, the set of control settings can dictate restrictions on usage of the client devices, such as restrictions on phone calls, messages, data usage, etc.

In some embodiments, a primary user account can select a set of default control settings for the subordinate user accounts. For example, a default set of control settings can be generated based on the age of a user of a subordinate user account. Further, the default set of control setting can be based on location, cultural norms, local trade associations, etc.

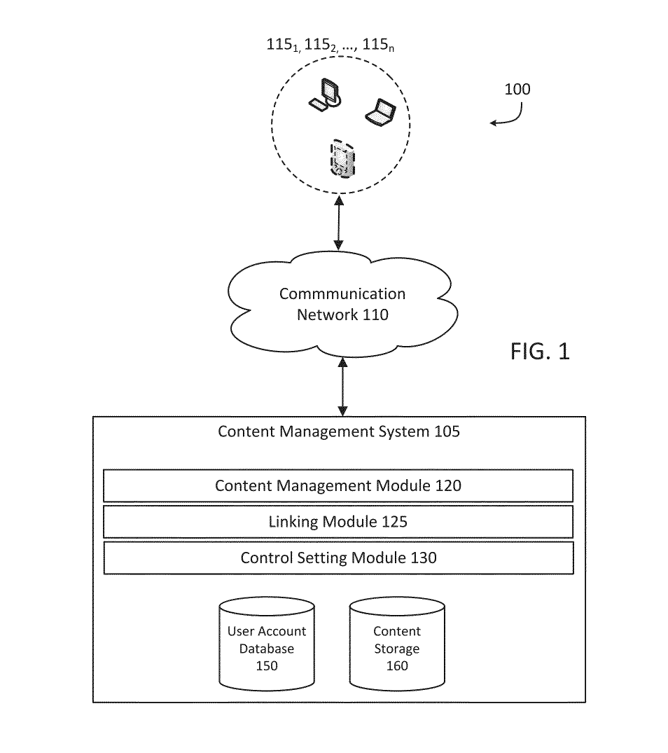

FIG. 1 illustrates an exemplary system configuration 100, wherein electronic devices communicate via a network for purposes of exchanging content and other data. As illustrated, multiple computing devices (client devices 115 and content management system 105) can be connected to communication network 110 and be configured to communicate with each other through use of communication network 110. Communication network 110 can be any type of network, including a local area network (“LAN”), such as an intranet, a wide area network (“WAN”), such as the internet, or any combination thereof. Further, communication network 110 can be a public network, a private network, or a combination thereof. Communication network 110 can also be implemented using any number of communications links associated with one or more service providers, including one or more wired communication links, one or more wireless communication links, or any combination thereof. Additionally, communication network 110 can be configured to support the transmission of data formatted using any number of protocols.

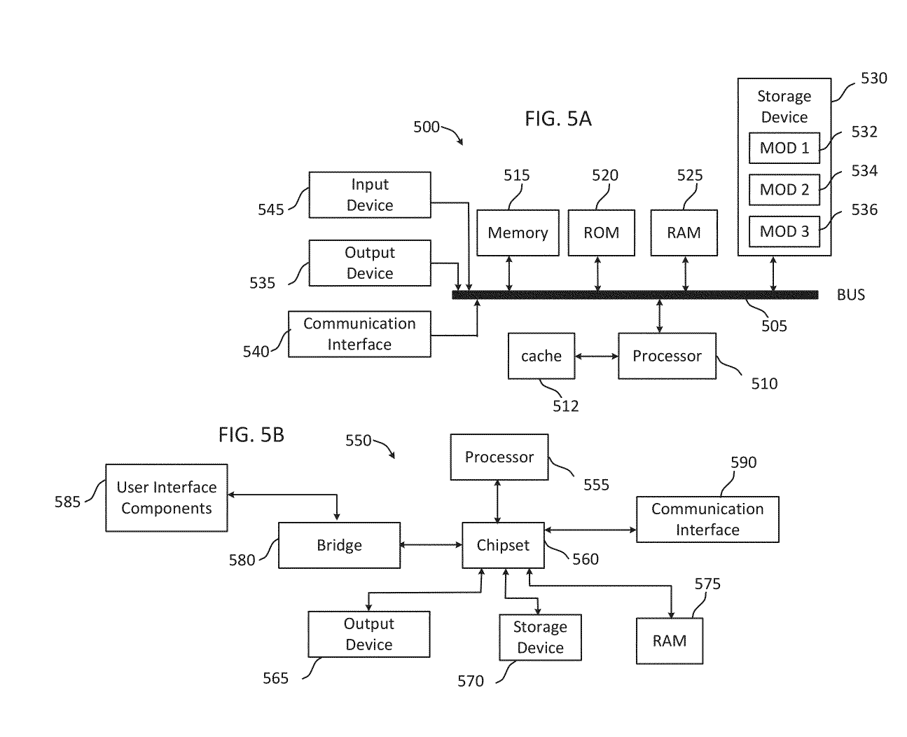

Multiple computing devices can be connected to communication network 110. A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 500 of FIGS. 5A and 5B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

In system 100, a user can interact with content management system 105 through client devices 115₁, 115₂, . . . , 115ₙ (collectively “115”) connected to communication network 110 by direct and/or indirect communication. Content management system 105 can support connections from a variety of different client devices 115, such as desktop computers; mobile computers; mobile communications devices, e.g. mobile phones, smart phones, tablets; smart televisions; set-top boxes; and/or any other network enabled computing devices. Client devices 115 can be of varying type, capabilities, operating systems, etc. Furthermore, content management system 105 can concurrently accept connections from and interact with multiple client devices 115.

A user can interact with content management system 105 via a client-side application installed on client device 115ᵢ. In some embodiments, the client-side application can include a content management system specific component. For example, the component can be a stand-alone application, one or more application plug-ins, and/or a browser extension. However, the user can also interact with content management system 105 via a third-party application, such as a web browser, that resides on client device 115ᵢ and is configured to communicate with content management system 105. In either case, the client-side application can present a user interface (UI) for the user to interact with content management system 105. For example, the user can interact with the content management system 105 via a client-side application integrated with the file system or via a webpage displayed using a web browser application.

Content management system 105 can be configured to manage content items for multiple user accounts. For example, content management system 105 can allow users to purchase, store and access content items. Furthermore, content management system 105 can make it possible for a user to access the content items from multiple client devices 115. Accessing a content item can include receiving metadata describing the content item, streaming the content item from content management system 105, downloading the content item or purchasing the content item.

To facilitate the various content management services, a user can create a user account with content management system 105. The account information for each created user account can be maintained in user account database 150. User account database 150 can store profile information for each user account, including a unique account identifier identifying the user account, personal information, username, password, email address, address, credit card information, banking information, client devices belonging to the user, etc. User account database 150 can also include account management information, such as content storage locations, security settings, personal configuration settings, client devices authorized to access the user account, etc.

A user account can be used to purchase, manage and store content items, such as digital data, documents, text files, audio files, video files, image files, etc. In some embodiments, a content item can be an item that is subject to a licensing restriction. For example, content management system 105 can provide an online content store where users can purchase a variety of content items. Further, in some embodiments, a user can upload content items from one of client devices 115 to content management system 105. The purchased and uploaded content items can be assigned to the user's user account and then accessed by the user from any of client devices 115 when logged into the user's user account. For example, a content item identifier identifying each content item assigned to a user account can be stored in user account database 150 and associated with the corresponding user account. The content item identifier can be used to identify the content item as well as the location of the content item.

The content items can be stored in content storage 160. Content storage 160 can be a storage device, multiple storage devices, or a server. Alternatively, content storage 160 can be a cloud storage provider or network storage accessible via one or more communications networks. Content management system 105 can hide the complexity and details from client devices 115 so that client devices 115 do not need to know exactly where the content items are being stored by content management system 105. Content management system 105 can store the content items in a network accessible storage (NAS) device, in a redundant array of inexpensive disks (RAID), etc. Content storage 160 can store content items using one or more partition types, such as FAT, FAT32, NTFS, EXT2, EXT3, EXT4, ReiserFS, BTRFS, and so forth.

Content storage 160 can also store metadata describing content items, content item types, and the relationship of content items to various user accounts. The metadata for a content item can be stored as part of the content item or can be stored separately. In one variation, each content item stored in content storage 160 can be assigned a system-wide unique identifier.

Content management system 105 can include content management module 120 configured to manage and access each user account and the content items assigned to the user accounts. For example, content management module 120 can be configured to communicate with user account database 150 and content storage 160 to adjust privileges with respect to content items and otherwise manage content items.

A user can communicate with content management system 105 via client device 115ᵢ to request to login into their user account. Content management system 105 can require that a user provide login credentials, such as a user name and password, to login into their user account. Upon receiving the correct login credentials for a user account, content management system 105 can authorize the requesting user's client device 115ᵢ on the user account, thereby allowing client device 115ᵢ to access content items assigned to the user account, make purchases with the payment method associated with the user account, assign content items to the user account, upload content items, etc.

In some embodiments, content management system 105 can limit the number of user accounts on which a client device 115 can be authorized at a time. For example, content management system 105 can limit a client device to being authorized on no more than one user account at a time. This can require a client device 115ᵢ to log out of a user account prior to logging into a different user account, thereby authorizing the client device on the different user account.

While content management system 105 can be configured to limit client devices 115 to being authorized on only one user account at a time, content management system 105 can allow for multiple client devices 115 to be authorized on the same user account simultaneously. This can allow a user to access their user account from multiple devices, such as their tablet PC, desktop PC and smartphone.

Upon a user logging into their user account from client device 115ᵢ thereby authorizing client device 115ᵢ on their user account, content management module 120 can access the account information associated with the user account to identify the content items assigned to the user account, as well as account configuration data dictating presentation of the content items. Content management module 120 can then present and/or provide the content items to client device 115ᵢ according to the account configuration data. For example, content management module 120 can access a user account to identify the content item identifiers assigned to the user account. The content item identifier can then be used to identify and locate the content items assigned to the user account, which can be transmitted to client device 115ᵢ, where they can be presented according to the account configuration data.

Presenting the content items can include transmitting metadata describing the content items to client device 105ᵢ that is authorized on the user account. Client device 105ᵢ can then use the received metadata to present the content items that the user account can access. For example, client device 105ᵢ can present information identifying the content items in a content item library available to the user account. This can include presenting the title of the content item, an image such as an album or book cover, description, etc.

Content management module 120 can also assign content items to a user account. For example, upon a user purchasing or uploading a content item, content management module 120 can add a content item identifier identifying the purchased content item to the user account in account database 150, thus enabling the user account to access the content item.

In some embodiments, content management system 105 can be configured to link multiple user accounts together to form a group of linked user accounts so that content items assigned to each of the individual user accounts can be accessed by each of the user accounts in the group linked user account. This can allow family members to link their user accounts together to share their content items with each other, while maintaining their personal user account.

To link user accounts together, content management system 105 can include linking module 125. In some embodiments, linking module 125 can be configured to provide an account link interface that enables a user to link their user account to other user accounts. For example, the account link interface can enable a user to request that their user account be linked to another user account and/or accept a request received from another user account. Upon logging into their user account, a user can use the account link interface to link their user account to the user account of other users.

To link multiple user accounts together, linking module 125 can be configured to modify the account information of the linked user accounts to indicate that the user accounts are linked together. For example, in some embodiments, linking module 125 can modify a user account to include the unique account identifier of each user account linked to the user account. Account management module 120 can then access a user account to identify each of the user accounts linked to the user account. Likewise, to unlink a user account, linking module 125 can modify the user account of each linked user account to remove the unique account identifier of the user accounts that are no longer linked.

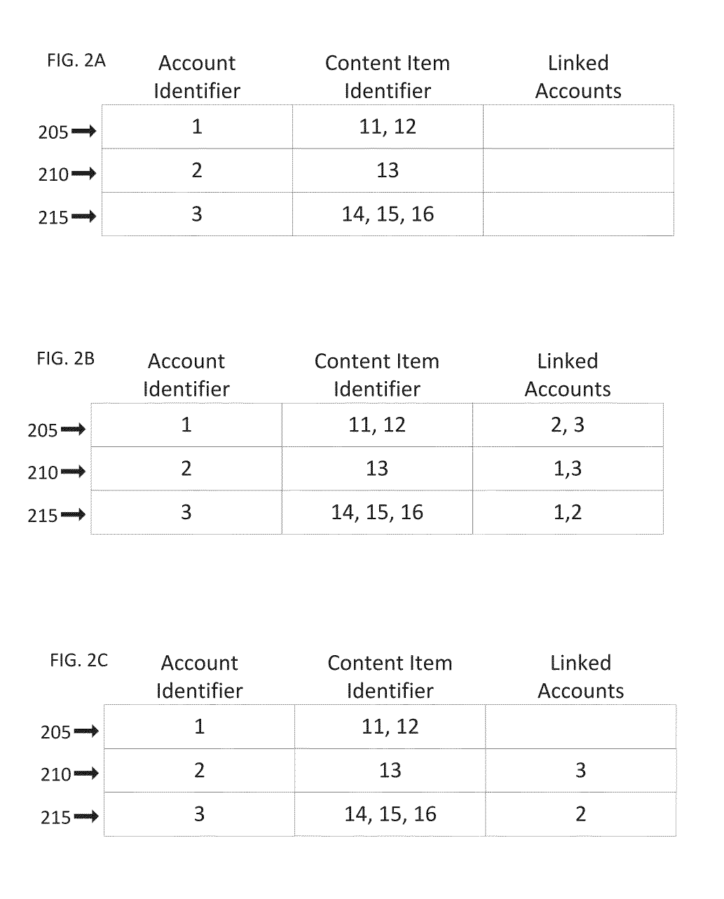

FIGS. 2A-2C illustrate an exemplary embodiment of linking multiple user accounts together. FIG. 2A, illustrates three user accounts: user account 205, user account 210 and user account 215. As shown, each user account (205, 210, 215) includes a unique account identifier field, a content item identifier field and a linked account field.

The unique account identifier field can include a unique account identifier that uniquely identifies a user account. As shown, the unique account identifier for user account 205 is 1; the unique account identifier for user account 210 is 2; and the unique account identifier for user account 215 is 3.

The content item identifier field can include content item identifiers identifying each content item assigned to the individual user account. As shown, content items 11 and 12 are assigned to user account 205, content item 13 is assigned to user account 210, and content items 14, 15 and 16 are assigned to user account 215.

The linked account field can identify the user accounts linked to a user account. For example, the linked account field can include the unique account identifier of each user account linked to the user account. As shown, none of the three user accounts (205, 210, 215) has a unique identifier in their respective linked account field, indicating that none of the user accounts (205, 210, 215) are linked to another user account. Each of the user accounts (205, 210, 215) can therefore access only the content items assigned to their respective user account. Thus user account 205 can access only content items 11 and 12, user account 210 can access only content item 13, and user account 215 can access only content items 14, 15 and 16.

FIG. 2B illustrates user accounts 205, 210 and 215 after they have been linked together to form a group of linked user accounts. As shown, user account 205 includes unique account identifiers 2 and 3 in the linked account field. This indicates that user account 205 is now linked to user accounts 210 and 215. Likewise, user account 210 includes the unique account identifiers 1 and 3 in its linked account field indicating that user account 210 is linked to user accounts 205 and 215, and user account 215 includes unique account identifiers 1 and 2 in its linked account field, indicating that user account 215 is linked to user accounts 205 and 210.

As a result of the user accounts 205, 210 and 215 being linked together, each of the user accounts (205, 210, 215) can access the content items assigned to the other user accounts, in addition to the content items assigned to the individual user account. For example, user account 205 can access content item 13 assigned to user account 210, and content items 14, 15 and 16 assigned to user account 215, in addition to the content items 11 and 12 assigned to user account 205. Likewise, user account 210 can access content items 11, 12, 14 15 and 16 in addition to the content items assigned to user account 210, and user account 215 can access content items 11, 12 and 13, in addition to the content items assigned to user account 215.

FIG. 2C illustrates user accounts 205, 210 and 215 after user account 205 has been removed from the group of linked user accounts. As shown, user account 215 no longer has any unique account identifiers listed in the linked account fields. This can indicate that user account 205 is no longer linked to any other user account. Further, the linked account fields of user accounts 210 and 215 have also been modified to remove the unique account identifier of user account 205, indicating that user accounts 210 and 215 are no longer linked to user account 205.

While user account 205 has been unlinked from user accounts 210 and 215, user accounts 210 and 215 remain linked to each other, as indicated by the linked account field of user accounts 210 and 215. As a result, user account 205 can access only the content items assigned to user account 205, and can no longer access the content items assigned to user accounts 210 and 215. Likewise, user accounts 210 and 215 can no longer access the content items assigned to user account 205, however user accounts 210 and 215 can still access the content items assigned to the other account. Thus, user account 205 can only access content items 11 and 12, whereas user accounts 210 and 215 can each access content items 13, 14, 15 and 16, but not content items 11 and 12.

Although listing unique account identifiers in a user account is used as one example of how user accounts can be linked together, this is only one possible embodiment and is not meant to be limiting. Linking multiple user account together can be performed in any of numerous ways known in the art.

In some embodiments, a unique group identifier can be used to identify a group of linked user accounts to which a user account belongs. A unique group identifier can identify one group of linked user accounts. Each user account can include a listing of unique group identifiers that identify each group of linked user accounts that include the user account belongs. A group index can be used to identify the user accounts included in each group of linked user accounts. For example, the group index can list each unique group identifier along with the unique account identifier for each user account included in the group. To identify the user accounts linked to a user account, the user account can be accessed to gather the group identifiers associated with the account. The group identifiers can then be used to search the group index to identify the user accounts included in each group.

Returning to the discussion of FIG. 1, in some embodiments, one or more of the user accounts in a group of linked user accounts can be designated as a primary user account that can be enabled with additional functionality not provided to the subordinate user accounts in the group of linked user accounts. A subordinate user account can be a user account in the group of linked user accounts that is not designated as a primary user account.

In some embodiments, the user account used to create a group of linked user accounts can be designated the primary user account. Alternatively, a user account can be designated as the primary user account after the group of user accounts has been created; for example, after receiving authorization from the members of the group of linked user accounts that the user account should be the primary user account.

In some embodiments, the user account that provides the payment method used to make purchases for the group can be designated the primary user account. Alternatively, the user account designated the primary user account can be required to provide a valid payment method.

In some embodiments, a primary user account can be enabled to select and modify a payment method used by the group of linked user accounts, such as a credit or bank account that is used for all purchases. As another example, a primary user account can be enabled to add a user account to the group of linked user accounts and/or select to remove a user account from the group of linked user accounts.

In some embodiments, the primary user account can be enabled to set restrictions on the subordinate user accounts included in the group of linked user accounts. For example, content management system 105 can maintain control settings for each group of linked user accounts. The control settings for a group of linked user accounts can define restrictions on the individual user accounts in the group of linked user accounts.

In some embodiments, the control settings can be stored in a control setting index that can be a file assigned to a primary user account. For example, the control setting index can be stored in user account database 150 and associated with a primary user and/or the group of linked user accounts. This can provide the primary user account with read/write access to modify the control setting index and therefore modify the control settings. In contrast, the subordinate user accounts in the group of linked user accounts can be restricted to read only access to the control setting index, thereby restricting subordinate user accounts from modifying the control settings.

Content management system 105 can include control setting module 130 configured to enable a primary user account to modify the control settings and set restrictions on subordinate user accounts included in the group of linked user accounts. This can allow a parent to set restrictions on their child's user account.

Control setting module 130 can be configured to provide a control setting interface that enables the primary user account to modify the control settings for subordinate user accounts in the group of linked user accounts. For example, control setting interface 130 can communicate with user account database 150 to identify the subordinate user accounts linked to a primary user account, and then present the subordinate user accounts in the control setting interface, where the primary user account can set restrictions for the presented subordinate user accounts. Control setting module 130 can further be configured to access the control setting index to determine the current control settings for the group of linked user accounts.

The control setting interface can provide necessary tools to set the control settings for each subordinate user account. For example, the control setting interface can include buttons, dropdown menus, etc., that allow the primary user account to select and adjust the control settings for a subordinate user account. Control setting module 130 can record the selected control settings in the control setting index for the group of linked user accounts.

Upon receiving a request from client device 115ᵢ, content management system 105 can identify the user account authorized on client device 115ᵢ, (i.e. the user account that the client device 115 is logged into at the time the request is received), and access the control setting index for the corresponding group of linked user accounts. Content management system 105 can then determine whether the user account is restricted from performing the request. If content management system 105 determines that the request is restricted by the control settings, content management system 105 can deny the request. Alternatively, if content management system 105 determines from the control settings that the user account is not restricted from performing the request, content management system 105 can execute the request.

In some embodiments, the control setting index can be stored on client devices 115 as well as maintained by content management system 105. For example, control setting module 130 can transmit the control setting index to client devices 115 associated with the user accounts included in the group of linked user accounts. This can include client devices 115 authorized on a user account included in the group of linked user accounts. Client devices 115 can be configured to condition execution of requests based on the received control settings. For example, upon receiving a request, client device 115ᵢ can determine from the received control settings whether the request is prohibited and, if so, deny the request. Alternatively, if the request is not prohibited, client device 115ᵢ can execute the request.

Transmitting the control setting file to client devices 115 can allow the restrictions to be enforced while client devices 115 are not in network connection with content management system 105. For example, client device 115ᵢ can have content items stored locally in memory on client device 115ᵢ. Maintaining the control setting index locally on client device 115ᵢ allows client device 115ᵢ to access the control setting index while a network connection with content management system 105 is not available. For example, if a user requests to access a local content item on client device 105, client device 105 can check the local control setting index to determine whether to grant access to the requested content item.

In some embodiments, client devices 115 can be required to receive approval from a primary user account prior to logging into a different user account. A child attempting to circumvent the restrictions placed on their subordinate user account can attempt to have a friend login to their unrestricted user account from the child's client device. Alternatively, the child can create a different user account that is not linked to the group of linked user accounts and therefore is not subject to the restrictions set by the primary user account. To prevent this, a client device 115ᵢ that has been authorized on a subordinate user account of a group of linked user accounts can be required to receive approval from a primary user of the group of linked user accounts prior to allowing client device 115ᵢ to login to a different user account. For example, client device 115ᵢ can require that a primary user's login credentials be provided prior to permitting a user to log client device 115 into a different user account.

Control setting module 130 can enable the primary user account to set a variety of restrictions on a subordinate user account. In some embodiments, control setting module 130 can be configured to enable the primary user account to set restrictions on the content items that can be accessed by a subordinate user account. Accessing a content item can include viewing, performing, purchasing, etc., a content item.

In some embodiments, control setting module 130 can be configured to enable the primary user account to set restrictions based on a rating associated with a content item. A parent can thus restrict their children from accessing content items associated with a specified rating such as PG-13, R, adult, mature, etc.

In some embodiments, control setting module 130 can be configured to enable the primary user account to set restrictions based on the content item type, such as whether a content item is a video, book, game, audio file, etc. A parent can thus restrict their child's user account from accessing videos and/or video games, while allowing access to books and music.

In some embodiments, control setting module 130 can be configured to enable the primary user account to set restrictions based on the content of a content item. For example, a parent can restrict movies that can be accessed by their child's user account based on the content of the movie, such as whether the movie is an action movie, comedy, romance, etc. Alternatively, a parent can restrict the music that can be accessed by their child's user account based on the type of music, such as rock-n-roll, rap, hip-hop, classical, etc.

In some embodiments, control setting module 130 can be configured to enable the primary user account to set restrictions based on the author of a content item. For example, a parent can restrict the books or articles that can be accessed by their child's user account based on the author of the book or article, and/or a magazine that published the article. Alternatively, a parent can restrict their child's user account from accessing music or movies authored, directed, etc., by a specified artist, director, screenwriter, etc.

In some embodiments, control setting module 130 can be configured to enable the primary user account to set restrictions on the number of content items that can be accessed by a user account. For example, a user account can be restricted to accessing a specified number of content items. If the restricted user account accesses the specified number of content items, further requests to access content items can be denied.

In some embodiments, control setting module 130 can enable the primary user account to set a recurring restriction that limits the number of content items that can be accessed per a specified time period, such as an hour, day, week, month, etc. If the restricted user account accesses the specified number of content items within the specified time period, further requests to access content items within the specified time period can be denied. The restricted user account can again begin accessing content items when the specified time period ends, such as the next day, week, etc.

In some embodiments, control setting module 130 can be configured to enable the primary user account to set restrictions on the amount of time that a subordinate user account can spend accessing content items. For example, a subordinate user account can be restricted to accessing ten hours of content items, after which further requests to access content items can be denied. A parent can thus limit the amount of time their child watches movies, listens to music, plays video games, etc. In some embodiments, the time restriction can be a recurring restriction that restricts the amount of time a user account can spend accessing content items per a specified time period, such as hour, day, week, month, etc. A parent can thus restrict the amount of time their child spends watching movies, paying video games, etc., per day.

In some embodiments, control setting module 130 can be configured to enable a primary user account to set restrictions on an amount of storage that can be allocated to content items assigned to a subordinate user account in the group of linked user accounts. For example, a user account can be restricted to a specified amount of storage space, such as five gigabyte of storage space. If the restricted user account requests to assign a content item to the user account that would cause the aggregate size of the content items assigned to the user account to exceed the specified limit, the request can be denied.

In some embodiments, control setting module 130 can enable the primary user account to set a restriction on the storage space allocated to a subordinate user account based on a percentage of the total storage space available to the group of linked user accounts. For example, a family can purchase a specified amount of storage space managed by content management system 105, and the purchased storage space can be shared amongst the family's group of linked user accounts. Control setting module 130 can enable the primary user account to restrict the subordinate user accounts in the group of linked user accounts to a specified percentage of the total space available to the group.

In some embodiments, control setting module 130 can enable the primary user account to set restrictions on purchases made by a subordinate user account in the group of linked user account. For example, the control setting interface can be configured to enable the primary user account to set restrictions on the monetary amount a subordinate user account can spend to purchase content items. A parent can thus set a limit on how much their child can spend on purchasing movies, games, in-app purchases, etc.

In some embodiments, the primary user account can set a one-time monetary limit that, upon exhaustion by the subordinate user account, results in further purchase requests made by the subordinate user account being denied. For example, a parent can set a one-time monetary limit of ten dollars on their child's user account, allowing the child to spend ten dollars to purchase content items. Upon the child spending ten dollars to purchase content items, future purchase requests made by the child can be denied. To make further purchases, the child could request that their parent authorize another one-time monetary limit.

Alternatively, in some embodiments, the primary user account can set a recurring monetary limit that is refreshed based on a set schedule such as on a specified time of day, day of the week or day of the month, etc. For example, a parent can set a recurring monetary limit of ten dollars on their child's user account that recurs monthly. A child that exhausted their monthly limit will have to wait until the next month to make further purchases. This can allow a parent to provide their child with a recurring allowance, such as ten dollars per month.

In some embodiments, the recurring monetary limit can compound such that the full monetary limit is added to any unused portion of the previous monetary amount allocated to the subordinate user account. For example, if a child's user account is restricted to ten dollars per month and the child only spent five dollars in a month, the next month allocation of ten dollars would be added to the remaining five dollars resulting in the child's user account being restricted to fifteen dollars in purchases. The child could then make fifteen dollars' worth of purchases. Although the child's user account would be restricted at a higher monetary limit, the recurring monetary limit would not increase. The recurring monetary limit would remain at ten dollars every month.

Alternatively, in some embodiments, the recurring monetary limit can set a strict monetary limit on the amount that can be spent by a subordinate user account during a specified time period. For example, if a child's user account is restricted to ten dollars monthly and the child only spent five dollars in a month, the next month the child's user account would be restricted to ten dollars. The recurring monetary limit would refresh to the set limit rather than compound with any unused portion.

It should be noted that, although a monetary limit placed on a subordinate user account allows the subordinate user account to make purchases up to the monetary limit, the monetary limit is a restriction on the subordinate user account rather than an allocation of funds to the user account. The primary user's payment method is not charged when the restriction is placed on the subordinate user account, but rather when a purchase is made by the subordinate user account.

In some embodiments, control setting module 130 can be configured to enable the primary user account to set an exception list to the restrictions placed on a subordinate user account. For example, a parent may wish to restrict their child from watching R rated movies in general but wish to create an exception to the rule for a specified R rated movie that the parent approves of. The parent can add the specific movie to the exception list associated with the restricted user account, thereby allowing the restricted user account to access the specific movie even though it has a restricted rating.

In some embodiments, control setting module 130 can be configured to enable the primary user account to set restrictions on a subordinate user account based on location. For example, a parent may wish to restrict their child's user account from accessing certain types of content items while at school, but allow their child to access those content items when at home. Control setting module 130 can enable the primary user account to set restrictions for a specified location. For example, the parent can select a geographic location and set a radius from the selected geographic location, within which a set of restrictions will apply.

The location of a subordinate user account can be determined from location data gathered from a client device 115 authorized to access the subordinate user account. For example, the location can be gathered from a Global Positioning Service component of client device 115. Alternatively, the location of the client device can be gathered from an IP address used by the client device 115.

In some embodiments, control setting module 130 can be configured to enable the primary user account to set restrictions on a subordinate user account based on time. For example, a parent may wish to be more restrictive with their child's user account on school nights, but less restrictive on the weekends. Alternatively, a parent may wish to be more restrictive with their child's user account during the day and less restrictive at night. Control setting module 130 can be configured to enable the primary user account to select a set of control settings based on time, such as time of day, day of the week, etc.

In some embodiments, control setting module 130 can be configured to enable the primary user account to set restrictions on usage of a client device 115. For example, a parent may wish to restrict the number of phone calls or messages sent by their child's phone. Alternatively, a parent may wish to restrict the amount of time their child spends talking on the phone or browsing the internet.

In some embodiments, control setting module 130 can be configured to enable a primary user account to set default restrictions on a subordinate user account. For example, a parent may not have the time to properly set the control settings for their child's user account. Control setting module 130 can be configured to generate a default set of control settings for a subordinate user account, which a primary user account can select to enforce on the subordinate user account.

In some embodiments, control setting module 130 can generate a default set of control settings for a subordinate user account based on the age of the user associated with the subordinate user account. Control setting module 130 can gather a user's age from the user's account in user account database 150 and select appropriate control settings based on the user's age. The default set of control settings for a specified age can be selected based on the user's age in relation to ratings and other local trade association guidelines. For example, the default control settings for a user age 12 can be set to restrict the user's account from accessing content items that are recommended for audiences older than 12. Thus, the default control settings generated for a 12 year old user can restrict the 12 year old user from accessing PG-13 movies, while the default control settings generated for a 14 year old allow the 14 year old user to access PG-13 movies.

In some embodiments, control setting module 130 can generate a default set of control settings based on a geographic location of the user. Control setting module 130 can gather the location of the user from the user's profile in user account database 150 and/or from a client device 115 authorized on the user account. Some geographic regions may have different cultural norms and standards and control setting module 130 can generate a default set of control settings that based on the local standards.

In some embodiments, control setting module 130 can be configured to automatically update the default control settings for a user account. For example, control setting module 130 can be configured to generate an updated set of default control setting for a user account on the user's birthday. The updated set of default control settings can be generated based on the user's update age. Alternatively, in some embodiments, the control setting module 130 can be configured to not update the default control settings once they have been generated for a user account. In this type of embodiment, a user can request a primary user to update the control settings as the user gets older.

In some embodiments, control setting module 130 can be configured to enable the primary user account to set restrictions on a client device 115 rather than a subordinate user account. For example, a parent may wish to restrict usage of their child's client device, regardless of the user account authorized on the client device. The restrictions placed on a client device can be enforced even if the restrictions on a user account authorized on the client device are more lenient than those placed on the client device. For example, if a parent sets a restriction on client device 115ᵢ that restricts client device 115ᵢ from accessing PG-13 rated movies, that restriction will be enforced when the parent's 15 year old child logs into their user account on client device 115ᵢ even if the 15 year old child's user account is not restricted from watching PG-13 movies. The restriction placed on client device 115ᵢ will trump the restrictions placed on a user account when the restriction placed on client device 115ᵢ is more restrictive than the restrictions placed on the user account.

The opposite, however, can be true when the restrictions placed on the user account are more restrictive than those on a client device. For example, if a parent sets a restriction on their child's user account that restricts the child's user account from accessing PG-13 movies, that restriction will be enforced even if the child logs into a client device 115ᵢ that allows PG-13 rated movies to be played. The restrictions placed on the user account can trump the restrictions placed on a client device when the restrictions placed on the user account are more restrictive than those placed on the client device.

Placing restrictions on a client device allows a primary user to restrict the data usage, phone usage, message, etc., for the client device regardless of the user that is using the client device. This can allow a parent to ensure that their child's smart phone will not exceed a specified phone/data limit that may cause overage charges.

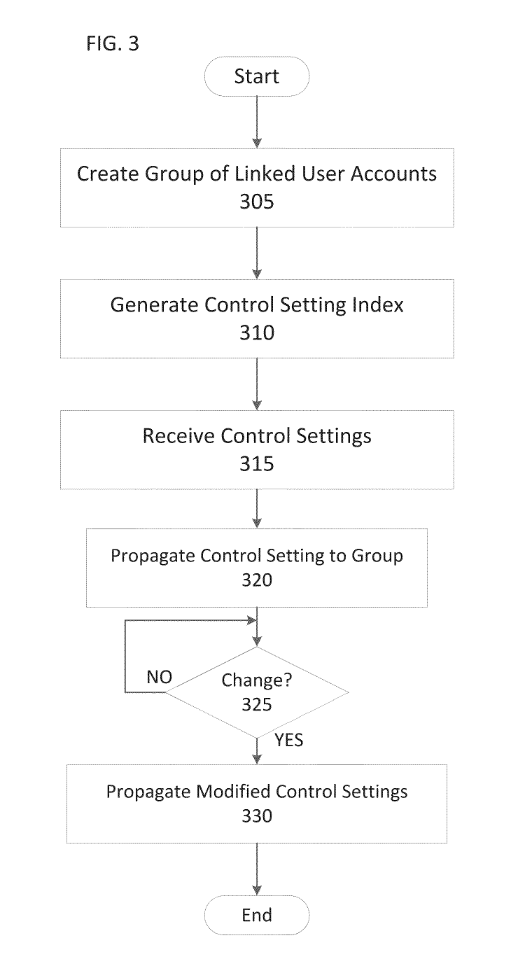

FIG. 3 illustrates an exemplary method embodiment of managing control settings for a group of linked user accounts. As shown, the method begins at block 305 where a group of linked user accounts is created. For example, linking module 135 can created a group of linked user accounts including a user accounts selected by a primary user. For example, upon selection by the primary user, linking module 135 can invite to selected users to join the group of linked user accounts. The group of linked user accounts can include the primary user account as well as the other user accounts that accepted the primary user's invitation to join the group of linked user accounts.

At block 310, control setting module 130 can generate a control setting for the group of linked user accounts. The control setting index can maintain a record of the control settings for the group of linked user accounts. To ensure that only the designated primary user account can modify the control settings for the group of linked user accounts, in some embodiments, the control setting index can be a file belonging to the primary user account. For example, the control setting index can be assigned to the primary user and/or stored within a container assigned to the primary user account. This can provide the primary user account with read/write access to the control setting index thereby enabling the primary user account to modify the control settings for the group of linked user accounts, while limiting the other user accounts to read only access, thereby restricting the other user accounts from modifying the control settings.

At block 315, control setting module 130 can receive control settings. For example, the primary user account can set control settings for the other user accounts in the group of linked user accounts. In some embodiments, the primary user account can manually set the control setting by selecting restriction on actions that can be performed by the various user accounts and/or client devices associated with the group of linked user accounts. Alternatively, in some embodiments, the primary user account can select default control settings based on the age of the users and/or their geographic location.

At block 320, control setting module 130 can propagate the set of control settings to the group of linked user accounts. In some embodiments, a read only version of the control setting index can be transmitted to the client devices authorized on a user account in the group of linked user accounts. Alternatively, in some embodiments, the client devices authorized on a user account in the group of linked user accounts can be notified of the control settings and instructed to request the control setting index. For example, a push notification can be transmitted to the client devices that instruct the client devices to pull the control settings.

At block 325, control setting module 130 determines whether there has been a change to the control setting index. For example, the primary user can provide their login credentials to login to the primary user account to which the control setting index is assigned. The primary user can access the control setting index and make changes to the control settings on the user accounts in the group of linked user accounts.

If at block 325, control setting module 130 determines that there has been a change to the control setting index, the method continues to block 330 where control setting module 130 propagates the modified control settings to the user accounts in the group of linked user accounts. For example, a push notification can be sent to the client devices authorized on a user account in the group of linked user accounts that instruct the client devices to pull the modified control settings.

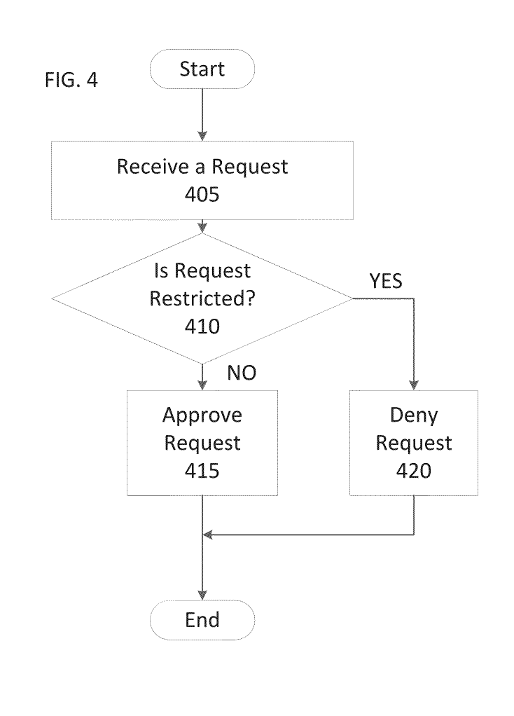

FIG. 4 illustrates an exemplary method of using control settings to restrict a user account. As shown, the method begins at block 405 where a request to perform an action is received. The request can be received from a client device authorized on a user account included in a group of linked user accounts. The request can be to perform any of a variety of actions, such as to access a content item, make a purchase, send an instant message, assign a content item to a user account, etc.

Upon receiving the request, the method continues to block 410 where it is determined whether the request is restricted. To accomplish this, a set of control setting defining restrictions on the user account can be analyzed. The set of control settings can indicate restrictions on the types of content items that can be accessed, action that can be performed, etc. If at block 410 it is determined that the requested action is restricted, the method continues to block 415 where the requested is granted. Alternatively, if at block 410 it is determined that the requested is restricted, the method continues to block 420 where the request is denied.

FIG. 5A, and FIG. 5B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 5A illustrates a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B illustrates a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, by a processor, from a first client device, while the first client device is authorized on a primary user account, a first set of control settings for a first subordinate user account linked to the primary user account, wherein the first set of control settings define restrictions on the first subordinate user account;
receiving, by the processor, from a second client device, while the second client device is authorized on the first subordinate user account, a first content request, wherein the first content request requests access to a first content item;
determining, by the processor, from the first set of control settings, that the first subordinate user account is restricted from accessing the first content item; and
denying, by the processor, the first content request.

2. The method of claim 1, further comprising:
receiving, from the first client device, while the second client device is authorized on the first subordinate user account, a second content request, wherein the second content request requests access to a second content item, different than the first content item;
determining, from the first set of control settings, that the first subordinate user account is authorized to access the second content item; and
granting the second content request, wherein access to the second content item is provided to the second client device.

3. The method of claim 1, further comprising:
receiving, from the second client device, while the second client device is authorized on a user account that is not linked to the primary user account, a third content request, wherein the third content request requests access to the first content item; and
granting the third content request, wherein access to the first content item is provided to the second client device.

4. The method of claim 1, further comprising:
receiving, from the first client device, while the first client device is authorized on the primary user account, a second set of control settings for the second client device, wherein the second set of control settings define restrictions on the second client device;
receiving, from the second client device, while the second client device is authorized to access a user account that is not linked to the primary user account, a fourth content request, wherein the fourth content request requests access to the first content item;
determining, from the second set of control settings, that the second client device is restricted from accessing the first content item; and
denying the fourth content request.

5. The method of claim 4, further comprising:
transmitting the second set of control settings to the second client device, wherein the second client device determines whether to allow content requests based on the second set of control settings.

6. The method of claim 1, further comprising:
generating a third set of control settings for a second subordinate user account that is linked to the primary user account, wherein:
the third set of control settings is generated based on an age of a user associated with the second subordinate user account, and
the third set of control settings define restrictions on the second subordinate user account;
receiving, from a third client device, while the third client device is authorized on the second subordinate user account, a fifth content request, wherein the fifth content request requests access to a third content item;
determining, from the third set of control setting, that the second subordinate user account is restricted from accessing the third content item; and
denying the fifth content request.

7. The method of claim 6, further comprising:
upon a determination that the age of the user associated with the second subordinate user account has changed, generated an updated third set of control setting for the second subordinate user account, wherein the updated third set of control settings:
is generated based on an updated age of the user associated with the second subordinate account,
define restrictions on the second subordinate account, and
replace the third set of control settings;
receiving, from the third client device, while the third client device is authorized on the second subordinate user account, a sixth content request, wherein the sixth content request requests access to the third content item;
determining, from the updated third set of control setting, that the second subordinate user account is authorized to access the third content item; and
granting the sixth content request, wherein access to the third content item is provided to the third client device.

8. A system comprising:
a processor; and
a memory containing instructions that, when executed, cause the processor to:
receive, from a first client device, while the first client device is authorized on a primary user account, a first set of control settings for a first subordinate user account linked to the primary user account, wherein the first set of control settings define restrictions on the first subordinate user account;
receive, from a second client device, while the second client device is authorized on the first subordinate user account, a first content request, wherein the first content request requests access to a first content item;
determine, from the first set of control settings, that the first subordinate user account is authorized to access the first content item; and
grant, the first content request, wherein access to the first content item is provided to the second client device.

9. The system of claim 8, wherein the instructions further cause the processor to:
receive, from the first client device, while the second client device is authorized on the first subordinate user account, a second content request, wherein the second content request requests access to a second content item, different than the first content item;
determine, from the first set of control settings, that the first subordinate user account is restricted from accessing the second content item; and
deny the second content request.

10. The system of claim 9, wherein the instructions further cause the processor to:
receive, from the second client device, while the second client device is authorized on a user account that is not linked to the primary user account, a third content request, wherein the third content request requests access to the second content item; and
grant the third content request, wherein access to the second content item is provided to the second client device.

11. The system of claim 8, wherein the instructions further cause the processor to:
receive, from the first client device, while the first client device is authorized on the primary user account, a second set of control settings for the second client device, wherein the second set of control settings define restrictions on the second client device;
receive, from the second client device, while the second client device is authorized to access a user account that is not linked to the primary user account, a fourth content request, wherein the fourth content request requests access to the first content item;
determine, from the second set of control settings, that the second client device is restricted from accessing the first content item; and
deny the fourth content request.

12. The system of claim 11, wherein the instructions further cause the processor to:
transmit the second set of control settings to the second client device, wherein the second client device determines whether to allow content requests based on the second set of control settings.

13. The system of claim 8, wherein the instructions further cause the processor to:
generate a third set of control settings for a second subordinate user account that is linked to the primary user account, wherein:
the third set of control settings is generated based on an age of a user associated with the second subordinate user account, and
the third set of control settings define restrictions on the second subordinate user account;
receive, from a third client device, while the third client device is authorized on the second subordinate user account, a fifth content request, wherein the fifth content request requests access to a third content item;
determine, from the third set of control setting, that the second subordinate user account is restricted from accessing the third content item; and
deny the fifth content request.

14. A method comprising:
receiving, by a first client device, while the first client device is authorized on a first subordinate user account, a first set of control settings for the first subordinate user account, wherein:
the first subordinate user account is linked to a primary user account,
the first set of control settings were set by the primary user account, and
the first set of control settings define restrictions on the first subordinate user account;
receiving, by the first client device, while the first client device is authorized on the first subordinate user account, a first request, wherein the first request requests to perform a first action;
determining, by the first client device, from the first set of control settings, that the first subordinate user account is restricted from performing the first action; and
denying, by the first client device, the first request.

15. The method of claim 14, further comprising:
receiving, by the first client device, while the first client device is authorized on the first subordinate user account, a second request, wherein the second request requests to perform a second action, different than the first action;
determining, from the first set of control settings, that the first subordinate user account is authorized to perform the second action; and
granting the second request.

16. The method of claim 14, further comprising:
receiving, by the first client device, while the first client device is authorized on a first user account that is not linked to the primary user account, a third request, wherein the third request requests to perform the first action; and
executing the third request.

17. The method of claim 16, further comprising:
receiving, by the first client device, a first authorization request to authorize the first client device on the first user account that is not linked to the primary user account;
receiving, from the primary user account, a verification approving the first authorization request; and
granting the first authorization request, resulting in the first client device being authorized on the first user account that is not linked to the primary user account.

18. The method of claim 14, further comprising:
receiving, by the first client device, a second authorization request to authorize the first client device on a second user account that is not linked to the primary user account; and
upon a determination that a verification approving the second authorization request was not received from the primary user account, denying the second authorization request.

19. The method of claim 14, further comprising:
receiving, by the first client device, a second set of control settings, wherein:
the second set of control settings were set by the primary user account, and
the second set of control settings define restrictions on the first client device;
receiving, by the first client device, while the first client device is authorized on a second user account, a fourth request, wherein:
the second user account is not linked to the primary user account, and
the fourth request requests to perform a third action;
determining, from the second set of control settings, that the first client device is restricted from performing the third action; and
denying the fourth request.

20. A non-transitory computer-readable medium containing instructions that, when executed by a client computing device, cause the client computing device to:
receive, while the client computing device is authorized on a first subordinate user account, a first set of control settings for the first subordinate user account, wherein:
the first subordinate user account is linked to a primary user account,
the first set of control settings were set by the primary user account, and
the first set of control settings define restrictions on the first subordinate user account;
receiving, while the client computing device is authorized on the first subordinate user account, a first request, wherein the first request requests to perform a first action;
determine, from the first set of control settings, that the first subordinate user account is restricted from performing the first action; and
deny, the first request.

21. The non-transitory computer-readable medium of claim 20, wherein the instructions further cause the client computing device to:
receive, while the client computing device is authorized on the first subordinate user account, a second request, wherein the second request requests to perform a second action, different than the first action;
determine, from the first set of control settings, that the first subordinate user account is authorized to perform the second action; and
grant the second request.

22. The non-transitory computer-readable medium of claim 20, wherein the instructions further cause the client computing device to:
receive, while the client computing device is authorized on a first user account that is not linked to the primary user account, a third request, wherein the third request requests to perform the first action; and
executing the third request.

23. The non-transitory computer-readable medium of claim 22, wherein the instructions further cause the client computing device to:
receive a first authorization request to authorize the client computing device on the first user account that is not linked to the primary user account;
receive, from the primary user account, a verification approving the first authorization request; and
grant the first authorization request, resulting in the client computing device being authorized on the first user account that is not linked to the primary user account.

24. The non-transitory computer-readable medium of claim 20, wherein the instructions further cause the client computing device to:
receive, a second authorization request to authorize the client computing device on a second user account that is not linked to the primary user account; and
upon a determination that a verification approving the second authorization request was not received from the primary user account, deny the second authorization request.

25. The non-transitory computer-readable medium of claim 20, wherein the instructions further cause the client computing device to:
receive a second set of control settings, wherein:
the second set of control settings were set by the primary user account, and
the second set of control settings define restrictions on the client computing device;
receive, while the first client device is authorized on a second user account, a fourth request, wherein:
the second user account is not linked to the primary user account, and
the fourth request requests to perform a third action;
determine, from the second set of control settings, that the client computing device is restricted from performing the third action; and
deny the fourth request.

26. A method comprising:
receiving, by a processor, from a first client device, while the first client device is authorized on a primary user account, a message to enforce default control setting on a first subordinate user account, wherein:
the first subordinate user account is linked to the primary user account, and
the primary user account is authorized to enforce control setting on the first subordinate user account; and
generating, by the processor, a set of default control settings based on an age of a user of the first subordinate user account, wherein the set of default control settings define restrictions of the first subordinate user account.

27. The method of claim 26, further comprising:
receiving, from a second client device, while the second client device is authorized on the first subordinate user account, a first content request, wherein the first content request requests access to a first content item;
determining, from the set of default control setting, that the first subordinate user account is restricted from accessing the first content item; and
denying the first content request.

28. The method of claim 27, further comprising:
determining, that the age of the user of the first subordinate user account has changed, generating an updated set of default control settings for the first subordinate user account, wherein the updated set of default control settings are generated based on an updated age of the user of the first subordinate user account, and the updated set of default control settings replace the set of default control settings to dictate restriction on the first subordinate user account.

29. The method of claim 28, further comprising:
receiving, from the second client device, while the second client device is authorized on the first subordinate user account, a second content request, wherein the second content request requests access to the first content item;
determining, from the updated set of default control setting, that the first subordinate user account is not restricted from accessing the first content item; and
granting the second content request.
